(19) United States
(12) Patent Application Publication
(10) Pub. No.: US 2007/0007274 A1
(43) Pub. Date: Jan. 11, 2007

(54) Heating resistive element and heating assembly comprising same

(76) Inventor: Christophe Aloup, Paris (FR)

Correspondence Address: Valeo Climate Control Corp.;Intellectual Property Department, 4100 North Atlantic Boulevard, Auburn Hills, MI, 48326, US

(21) Appl. No.: 10/570,961

(22) PCT Filed: Sep. 11, 2003
(86) PCT No.: PCT/IB04/02876

§ 371 Date: Mar. 8, 2006

(30) Foreign Application Priority Data
Sep. 11, 2003 (FR) 03 10686

(51) Int. Cl. H05B 3/68

(52) U.S. Cl. 219/444.1

(57) ABSTRACT

The invention relates to a heating element (10) for dissipating heat when a potential difference is applied to the connecting ends (18, 20) thereof. According to the invention, said element includes a plurality of mutually electrically connected and spaced-apart resistive walls (14).

This invention relates to a heating element capable of dissipating heat when a potential difference is applied to its connection ends.

It relates in particular to a heating element for an electrical heating radiator, for example, an additional radiator for a motor vehicle air conditioning device.

Heat exchanger heating elements that comprise resistive elements are already known. They can be positive temperature coefficient (PTC) resistors in the form of blocks or stones.

A known technique consists of using these stones to form heating bars which are inserted into tubes which are themselves assembled to radiant elements.

A disadvantage lies in the fact that the resistive heating elements are small and must be integrated in a support that includes numerous parts arranged with respect to one another.

In addition to its complexity, this support has the disadvantage of requiring both mechanical maintenance of the stones spaced apart from one another as well as the electrical contact between the stones and the power bars.

Moreover, the heating element must have surfaces for exchanging heat with the surrounding air, so the existing heating elements have blades or the like, thermally connected to the resistive heating elements, which further complicates its structure.

The invention aims to provide a heating element that substantially overcomes these disadvantages.

This goal is achieved by including a plurality of resistive walls, electrically connected to and spaced apart from one another.

The walls can have planar surfaces and be connected by forming an angle between them so as to form one or more polyhedrons. They can also have non-rectilinear sections and, for example, have concave or convex sides. In other words, it is possible for the walls, and therefore the heating element, to have the desired shape.

In general, the walls are thin, with a thickness of between 0.2 mm and 2 mm, for example.

The walls of the heating element according to the invention act as electrical resistors and are mutually connected while being spaced apart from one another. This means that there are at least two walls that are not joined to one another at their larges surface. In other words, there can be at least two walls that, while being mutually electrically connected by means of other walls or electrical conductors, are separated from one another by a space free of material. This space is preferably a through-space so that the surfaces of these walls constitute surfaces for exchanging heat with the surrounding environment.

The heating element advantageously includes a plurality of basic resistive elements each having at least one resistive wall.

The juxtaposition of the basic resistive elements constitutes the heating element, and it is possible for a basic resistive element to be integrally formed with one resistive wall (in the case of a cylindrical element) or a plurality of resistive walls.

The basic heating elements are advantageously hollow cells of which the walls form said resistive walls.

Thus, according to the invention, the heating element consists of a plurality of cells, of which the walls are the resistive walls of the invention and which are preferably hollow throughout so as to be open at their two ends toward the external environment to be heated.

The cells can also open only from one side, for example if the heating element is joined to a wall of a conduit.

The cross-section of a cell advantageously has a polygonal shape.

The walls of the cells are parallel to the same generating line, which defines their longitudinal direction, to which their cross-sections are perpendicular.

Thus, each cell can have the shape of a hollow prism of which the base is polygonal, for example square or hexagonal, and the prism is advantageously open at its base and at its opposite end, so that the opening passes through the cell.

The structure of the heating element advantageously has a honeycomb shape, i.e. a structure having identical hollow cells, jointed to one another and opening at least on one side toward the heating element, and preferably on its two opposite sides.

The heating element preferably has a general parallelepiped shape, but other general shapes can also be considered: for example, rounded shapes if the heating element is to surround an object to be heated.

The resistive walls advantageously act as positive temperature coefficient (PTC) resistors.

The positive temperature coefficient resistors have an advantage with regard to safety because they enable any overheating to be prevented by self-regulation.

The resistive walls are advantageously formed with a polymer material.

The benefit of using a polymer instead of conventional resistant materials such as stone or ceramic block lies in the fact that the polymer is less expensive and can be modeled more easily than stone or ceramic block.

In particular, it is possible to give it almost any geometric shape and, consequently, to form the hollow cells in the shape of a honeycomb according to the invention, both easily and inexpensively.

The polymer can be, for example, a fluoropolymer.

Moreover, additional substances are generally added to the polymer so as to render the walls electrically conductive. The material thus formed preferably has the properties of a positive temperature coefficient resistor.

The polymer material is advantageously filled with at least one additive giving the material the resistive and conductive properties.

The heating element is advantageously made by molding.

In practice, the filled material according to the invention is molded so as to obtain the desired shape. The molding of a radiator-type heating element is highly advantageous if a heating element with a complex spatial shape is desired.

In addition, the molding of a polymer material is a relatively simple and inexpensive operation.

The invention also relates to a heating assembly including a heating element according to the invention and two terminals electrically connected to said heating element and secured to the connection ends by the latter.

The heating element is therefore powered with an electrical current directly through its connection ends, preferably located at the ends of the heating element, by means of two terminals.

A connection end generally consists of a group of cells bordering the heating element at one of its ends.

To ensure electrical contact between the terminals and the connection ends of the heating element and to prevent any disconnection that may be caused, for example, by vehicle vibrations, the terminals are secured to the connection ends.

The heating element is advantageously formed by molding and the terminals are secured to the connection ends of said element by overmolding.

Overmolding, which consists of using a portion of the terminals as an insert for molding the heating element, makes it possible to secure the terminals to the connection ends of the heating element simply and effectively.

This solution makes it possible to avoid using the additional parts that are normally used in radiators: contact blades, lateral support bars, springs and support spacers for PTC stones.

The invention can be better understood and its advantages will be more clear from the following detailed description of embodiments indicated by way of non-limiting examples. The description refers to the appended drawings in which:

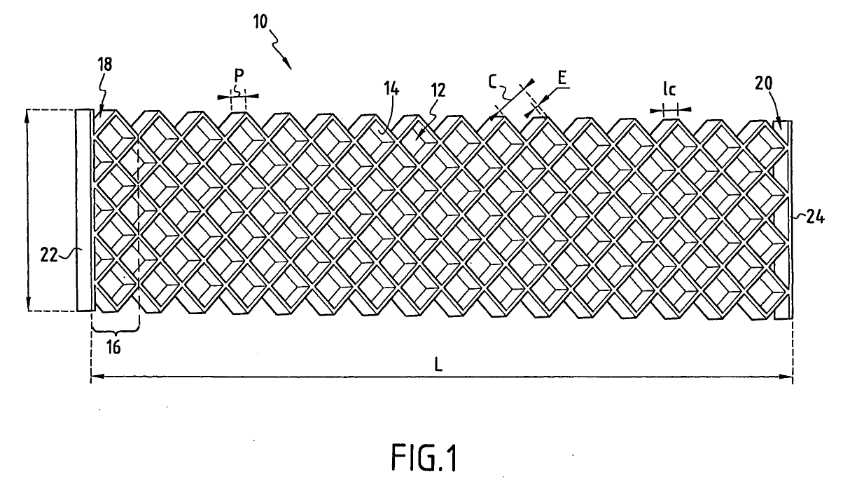

FIG. 1 is a perspective view of a heating element according to a first embodiment of the invention;

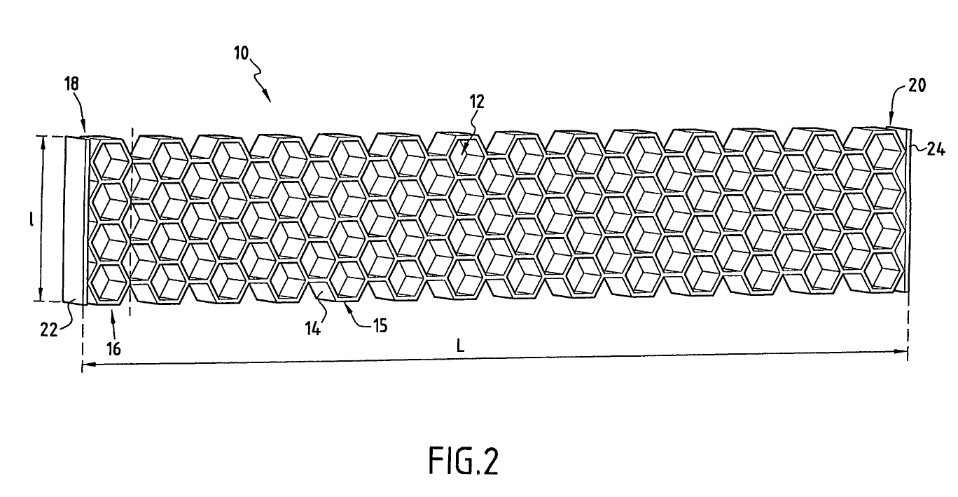

FIG. 2 is a perspective view of a heating element according to a second embodiment of the invention;

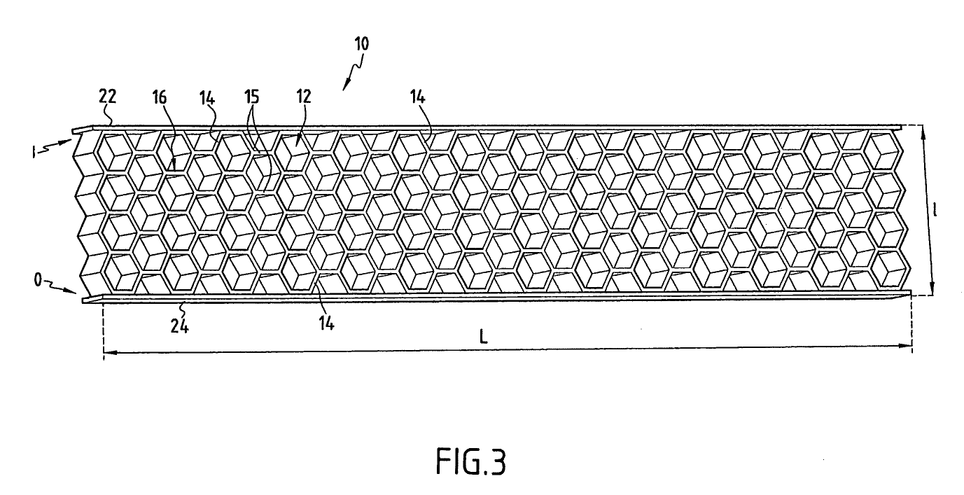

FIG. 3 is a perspective view of a heating element according to a third embodiment of the invention; and

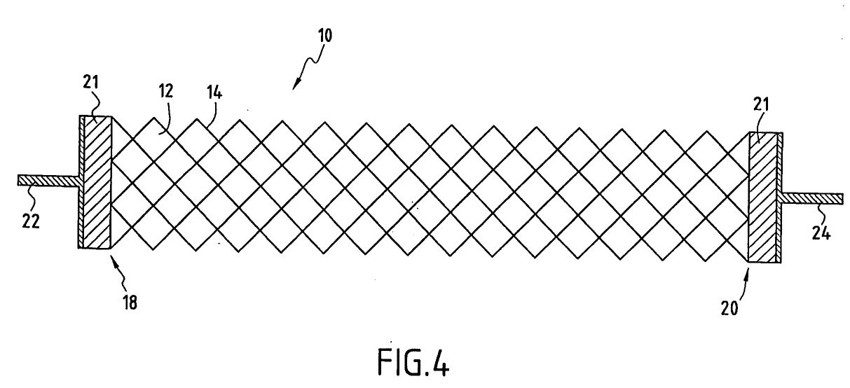

FIG. 4 is a front view of a heating assembly according to a first embodiment of the invention.

FIG. 1 shows a heating element 10 according to a first embodiment.

The heating element 10 has a general parallelepiped shape of length L, of width l and of depth P. It consists of a plurality of identical cells 12 that have the shape of a right polyhedron with a square cross-section extending longitudinally in the direction of the depth P.

The cells 12 are juxtaposed next to one another, while all being parallel to the direction of the depth of the element 10.

It is therefore understood, with the help of FIG. 1, that the length I_{c} of the cells 12 defines the depth P of the heating element 10.

Each cell consists of four side walls 14 which are perpendicular two-by-two so as to have a square cross-section. The walls 14 are identical and each have the shape of a parallelepiped of length P, of width C equal to the side of a cell and of thickness E.

As seen in FIG. 1, the cells 12 are preferably hollow and open at their two ends. It is also possible to consider hollow cells 12 that are open only on one side.

According to the example of FIG. 1, two adjacent hollow cells 12 can have common wall 14 or a common edge that corresponds to the intersection of two adjacent walls 14.

In the heating element 10, the cells are arranged in columns 16, which extend in the transverse direction of the heating element 10. Each of these columns 16 has the same number m of cells, and the heating element 10 includes n mutually juxtaposed and parallel columns 16. The height of a column 16 defines the width l of the heating element 10, and the length of the n columns 16 defines the length L of the heating element 10.

FIGS. 2 and 3 show a second and a third embodiment of a heating element 10 according to the invention. Unlike the example shown in FIG. 1, the cross-section of a hollow cell 12 has a hexagonal shape.

Another difference with respect to the example shown in FIG. 1 lies in the number of hollow cells 12 per column 16: in the examples shown in FIGS. 2 and 3, the columns 16 alternatively contain m and m−1 hollow cells 12. This is due to the hexagonal shape of the cross-section. In this case, the width l of the heating element 10 is defined by the height of a column 16 containing m hollow cells 12.

The physical properties of the walls 14 will now be discussed.

Each wall 14 is at least partially made of a polymer material that can be, for example, a fluoropolymer. This polymer is preferably filled with additives enhancing the conductivity of the polymer. Such additives give the polymer PTC-effect conductive properties. This means that the material thus formed is capable of dissipating heat in a self-regulated manner.

The heating element 10 is powered with an electrical current by applying a potential difference V between the connection ends 18, 20 of the heating element 10. These connection ends 18, 20 are located at the ends of the heating element 10. In the example shown in FIGS. 1 and 2, the connection ends 18, 20 are formed by hollow cells 12 located on the edges of either side of the greatest length L of the heating element 10, and, in the example shown in FIG. 3, the connection ends 18, 20 are formed by hollow cells 12 located on the edges of either side of the width l of the heating element 10.

The principle of increasing the resistance as a function of the temperature is based on the fact that the polymer becomes heated and dilated. This dilation causes a separation of the conductive particles, which leads to a reduction in the passage of the electrical current and, consequently, an increase in the resistance. The PTC effect is thus obtained by the dilation of the polymer combined with the electrical conductivity of the material of the conductive particles.

Of course, a person skilled in the art can perform tests in order to choose the content of polymer filler particles so as to obtain the desired PTC effect.

Each so-called resistive wall 14 has a resistance value.

For example, in the embodiment shown in FIG. 1, all of the resistive walls 14 have the same resistance R allowing for homogenous heat dissipation.

It is thus demonstrated that the equivalent resistance of the heating element 10 is a function of the number of hollow cells 12 per column 16 and of the number of columns 16. More precisely, the equivalent resistance is:

$${R}_{equivalent} ( m , n ) = n \times \frac{R}{m}$$

The corresponding dissipated power is:

$${P}_{dissipated} ( m , n ) = \frac{{V}^{2}}{n \times \frac{R}{m}}$$

Where n is the number of columns 16 and m is the number of hollow cells 12 per column 16 and V is the potential difference applied between the connection ends 18, 20 of the heating element 10.

In the second embodiment, shown in FIG. 2, the walls do not all have the same resistance. To homogenize the dissipated power, for the two walls 15 that are parallel to the longitudinal direction of the heating element 10, a resistance of R/4 is chosen, while R is the resistance of the other resistive walls 14.

It is shown that the equivalent resistance is:

$${R}_{equivalent} ( m , n ) = \frac{R}{4} \times ( \frac{m + 1}{\frac{2}{9} + \frac{n}{5}} + \frac{m}{n + 1} )$$

with:

$$m = \frac{b}{2} + 1 and n = a - 1$$

Where a is the number of hollow cells 12 in the first column 16 and b is the number of columns 16.

The corresponding dissipated power is:

$${P}_{dissipated} ( m , n ) = \frac{{V}^{2}}{\frac{R}{4} \times ( \frac{m + 1}{\frac{2}{9} + \frac{n}{5}} + \frac{m}{n + 1} )}$$

Where V is the potential difference applied to the connection ends 18, 20 of the heating element 10.

In the third embodiment, shown in FIG. 3, the walls do not all have the same resistance.

To homogenize the dissipated power, for the two walls 15 that are parallel to the longitudinal direction of the heating element 10, a resistance of R/4 is chosen, while R is the resistance of the other resistive walls 14.

It is shown that the equivalent resistance is:

$${R}_{equivalent} ( m , n ) = n \times \frac{R}{m}$$

with:
m=b+1 and n=2a

Where a is the number of hollow cells 12 in the first column 16 and b is the number of columns 16.

The corresponding dissipated power is:

$${P}_{dissipated} ( m , n ) = \frac{{V}^{2}}{n \times \frac{R}{m}}$$

Where V is the potential difference applied to the connection ends 18, 20 of the heating element 10.

The heating element 10 is preferably formed by molding, for example from filled polymer pellets.

These pellets are brought to a high temperature so as to have the desired viscosity and form a paste that is injected into a mold having the shape of the heating element 10.

When the heating element 10 is used, it is integrated into a heating assembly that also includes two terminals 22, 24.

These terminals 22, 24, which can be seen in FIGS. 1 to 4, are rods or metal plates connected to a voltage generator (not shown here) and to the connection ends 18, 20 of the heating element 10.

To ensure reliable electrical contact between the connection ends 18, 20 and the terminals 22, 24, the latter are secured to the heating element 10 by overmolding.

As seen in FIG. 4, the overmolding of the terminals 22, 24 consists of including these terminals in the molding operation.

The terminals are preferably molded directly with the polymer in a single step, without any further molding.

For example, the heating element can include plates 21 formed in the same material as the cells and which are located between the connection ends and the terminals so as to ensure good electrical contact between the terminals and the connection ends. Such plates 21 are shown diagrammatically in FIG. 4.

The terminals 22, 24 are therefore rigidly secured to the heating element 10 and the risk of a disconnection of the electrical connection between the connection ends 18, 20 and the terminals 22, 24 is thus overcome.

The molding makes it possible to consider heating element 10 structures specific to the object to be heated. The molding makes it possible to easily design heating elements 10 with a complex geometric structure. It is also possible to calibrate the dissipated thermal power by choosing the density of hollow cells 12 or their shape.

For example, this heating assembly can be integrated in an electrical heating radiator for a motor vehicle air conditioning device.

It can also be used in a supply grille so as to heat a vehicle cabin or it can, for example, be incorporated in an automobile seat so as to heat the latter.

1. Heating element (10) capable of dissipating heat when a potential difference is applied to its connection ends (18, 20), characterized in that it includes a plurality of resistive walls (14), electrically connected to and spaced apart from one another.

2. Heating element (10) according to claims 1, characterized in that it includes a plurality of basic resistive elements (12) each having at least one resistive wall (14).

3. Heating element (10) according to claim 1 or 2, characterized in that the basic resistive elements are hollow cells (12) of which the walls (14) form said resistive walls (14).

4. Heating element (10) according to claim 3, characterized in that the cells (12) are mutually parallel.

5. Heating element (10) according to claim 3 or 4, characterized in that the cross-section of a cell (12) has a polygonal shape.

6. Heating element (10) according to claim 5, characterized in that two adjacent cells (12) have at least one common side or edge.

7. Heating element (10) according to any one of claims 1 to 6, characterized in that it has a “honeycomb” structure.

8. Heating element (10) according to any one of claims 1 to 7, characterized in that the resistive walls (14) act as positive temperature coefficient resistors.

9. Heating element (10) according to any one of claims 1 to 8, characterized in that the resistive walls (14) are at least partially made of a polymer material.

10. Heating element (10) according to claim 9, characterized in that the polymer material is filled with at least one additive giving the material resistive and conductive properties.

11. Heating element (10) according to any one of claims 1 to 10, characterized in that it is formed by molding.

12. Heating assembly characterized in that it includes a heating element (10) according to any one of claims 1 to 11, and two terminals (22, 24) electrically connected to said heating element (10) and secured to the connection ends (18, 20).

13. Heating assembly according to claim 12, characterized in that the heating element (10) is formed by molding and in that the terminals (22, 24) are secured to the connection ends (18, 20) of said element (10) by overmolding.

14. Electrical heating radiator for a motor vehicle air conditioning device characterized in that it includes a heating assembly according to claim 12 or 13.
